(19) United States
(12) Patent Application Publication
(10) Pub. No.: US 2024/0383769 A1
(43) Pub. Date: Nov. 21, 2024

(54) TEMPLATE GROWTH METHOD FOR PREPARING LITHIUM COBALTATE PRECURSOR AND USE THEREOF

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Haijun Yu, Foshan, Guangdong (CN); Yinghao Xie, Foshan, Guangdong (CN); Aixia Li, Foshan, Guangdong (CN); Xuemei Zhang, Foshan, Guangdong (CN); Changdong Li, Foshan, Guangdong (CN)

(21) Appl. No.: 18/694,430

(22) PCT Filed: Feb. 20, 2023
(86) PCT No.: PCT/CN2023/077217

§ 371 Date: Mar. 22, 2024

(30) Foreign Application Priority Data
Apr. 25, 2022 (CN) 202210438608.7

(51) Int. Cl. C01G 51/00

(52) U.S. Cl. CPC C01G 51/42; C01P 2004/03; C01P 2006/40

(57) ABSTRACT

Provided are a template growth method for preparing a lithium cobaltate precursor and use. The method comprises: S1: mixing an aqueous ammonium metavanadate solution with a polyvinylpyrrolidone solution for hydrothermal reaction, and calcining the obtained precipitate under an aerobic atmosphere to obtain a vanadium pentoxide structure-directing agent, wherein the polyvinylpyrrolidone solution is prepared by dissolving polyvinylpyrrolidone in an alcohol; S2: adding the vanadium pentoxide structure-directing agent to a cobalt salt solution to obtain a turbid liquid, adding the turbid liquid, a carbonate solution, and a complexing agent in a parallel flow mode for reaction, and performing aging when the reaction material reaches a target particle size; and S3: performing solid-liquid separation on the aged material, and anaerobically calcining the obtained precipitate before aerobic calcination to obtain a lithium cobaltate precursor. Also provided is use of the method in preparing lithium cobaltate or a lithium ion battery.

### TECHNICAL FIELD

The present disclosure belongs to the technical field of lithium battery cathode materials, and specifically relates to a method for preparing a lithium cobalt oxide (LCO) precursor through template-induced growth and use thereof.

### BACKGROUND

With advantages such as high specific energy, light weight, and environmental friendliness, lithium-ion batteries (LIBs) have been widely used in digital products, household appliances, electric vehicles, aerospace, satellites, and weaponry, and play an increasingly-important role in civil and aerospace-grade military fields. As portable electronic devices such as mobile phones, digital cameras, and notebook computers become increasingly more miniature, lighter, and thinner, the market places ever growing high requirements for energy density, electrochemical performance, and safety of LIBs.

LiCoO₂ (Lithium cobalt oxide, LCO) cathode material has the advantages of high voltage plateau, excellent cycling performance, high compacted density, and so on, and thus is one of the earliest commercialized cathode materials. However, due to the structure of LCO itself, when a charging voltage exceeds 4.2 V, a deintercalation coefficient x of Li₁₋ₓCoO₂ is greater than or equal to 0.5 and its internal structure collapses, which will lead to a series of problems such as poor charge-discharge cycling performance at the high voltage and poor high-temperature storage performance. Therefore, in order to improve the discharge capacity and energy density of a battery by increasing a charge cut-off voltage of the battery, it is necessary to first modify these cathode materials to solve many problems caused by the increase in charge cut-off voltage.

The doping modification of an LCO material can improve the structural stability of the material before and after a charge-discharge process, inhibit the generation of phase transition, and increase the delithiation degree, and the capacity and electric conductivity of the material. According to the theory of crystal chemistry, sometimes the doping of a small amount of a foreign element leads to crystal defects, which can increase the diffusion rate of ions in a bulk phase. According to the energy band theory, a p-type or n-type semiconductor can be produced by doping a semiconductor compound with high-valent or low-valent ions, which can increase the electric conductivity of the crystal. In recent years, the influence of doping with different metal elements (Mg, Al, and Zr) on the electrochemical performance of an LCO cathode material has been explored by researchers. However, there are few reports on LCO cathode materials substituted with a small amount of vanadium.

### SUMMARY

The present disclosure is intended to solve at least one of the above-described technical problems existing in the prior art. In view of this, the present disclosure provides a method for preparing an LCO precursor through template-induced growth and use thereof. In the method, a vanadium pentoxide particle is preprepared as a template agent, and then vanadium is doped during co-precipitation to obtain an element vanadium-doped LCO precursor.

According to an aspect of the present disclosure, a method for preparing an LCO precursor through template-induced growth is provided, including the following steps:
S1: mixing an ammonium metavanadate (AMV) aqueous solution with a polyvinylpyrrolidone (PVP) solution to allow a hydrothermal reaction, and subjecting a resulting precipitate to calcination in an aerobic atmosphere to obtain a vanadium pentoxide template agent, where the PVP solution is prepared by dissolving PVP in an alcohol;
S2: adding the vanadium pentoxide template agent to a cobalt salt solution to obtain a suspension, concurrently feeding the suspension, a carbonate solution, and a complexing agent to allow a reaction, and when a particle size of a reacted material reaches a target value, conducting aging; and
S3: conducting solid-liquid separation (SLS) on an aged material to obtain a precipitate, and subjecting the precipitate first to anaerobic calcination and then to aerobic calcination to obtain the LCO precursor.

In some embodiments of the present disclosure, in S1, the AMV aqueous solution may be prepared by dissolving AMV in water; and the AMV, the water, the PVP, and the alcohol may be in a ratio of (1-3) g:(25-35) mL:(8-12) g:(90-110) mL.

In some preferred embodiments of the present disclosure, in S1, the alcohol may be ethylene glycol (EG).

In some embodiments of the present disclosure, in S1, the hydrothermal reaction may be conducted at 170° C. to 190° C. for 20 h to 28 h.

In some embodiments of the present disclosure, in S1, the vanadium pentoxide template agent may have a particle size of 50 nm to 100 nm. The vanadium pentoxide template agent is micro-spherical, and the particle size of the vanadium pentoxide template agent cannot be too large or too small. If the template agent has a too small particle size, it will dissolve too fast, and cannot play a role of seed crystal well. If the template agent has a too large particle size, the dissolution will be too slow, and less cobalt vanadate will be produced. Therefore, when the vanadium pentoxide has a particle size of 50 nm to 100 nm, it can be ensured that the vanadium pentoxide is dissolved and a cobalt vanadate precipitate is produced at the same time, while it serves as a template agent.

In some embodiments of the present disclosure, in S1, the calcination may be conducted at 450° C. to 550° C. for 1 h to 3 h.

In some embodiments of the present disclosure, in S2, the cobalt salt solution may have a concentration of 1.0 mol/L to 2.0 mol/L; and a molar ratio of cobalt in the cobalt salt solution to vanadium in the vanadium pentoxide template agent may be 10:(0.1-2).

In some embodiments of the present disclosure, in S2, the cobalt salt solution may be at least one of a cobalt sulfate solution, a cobalt nitrate solution, and a cobalt chloride solution.

In some embodiments of the present disclosure, in S2, the carbonate solution may be a sodium carbonate solution with a concentration of 1.0 mol/L to 2.0 mol/L.

In some embodiments of the present disclosure, in S2, the complexing agent may be aqueous ammonia with a concentration of 6.0 mol/L to 12.0 mol/L.

In some embodiments of the present disclosure, in S2, the reaction may be conducted at a pH of 8 to 9, a temperature of 70° C. to 80° C., and an ammonia concentration of 5 g/L to 10 g/L.

In some embodiments of the present disclosure, in S2, the reaction may be conducted at a stirring speed of 200 r/min to 500 r/min.

In some embodiments of the present disclosure, in S2, the aging may be conducted for 48 h to 72 h.

In some embodiments of the present disclosure, in S2, the target value of the particle size of the reacted material may be 4.0 μm to 8.0 μm.

In some embodiments of the present disclosure, in S3, before the anaerobic calcination, the precipitate may be further washed with water and dried; and the drying may be conducted at 100° C. to 200° C. for 10 h to 30 h.

In some embodiments of the present disclosure, in S3, the anaerobic calcination may be conducted as follows: introducing an inert gas, heating from room temperature to a temperature of 200° C. to 300° C. at a heating rate of 0.5° C./min to 10° C./min and holding the temperature for 4 h to 6 h, and then heating to a temperature of 600° C. to 800° C. and holding the temperature for 1 h to 2 h; and the aerobic calcination may be conducted as follows: introducing an oxidizing gas, and holding the temperature of 600° C. to 800° C. for 4 h to 6 h.

The present disclosure also provides use of the method described above in the preparation of LCO or an LIB.

In some embodiments of the present disclosure, a method for preparing the LCO may include: mixing the LCO precursor with a lithium source, and roasting a resulting mixture in an aerobic atmosphere.

In some embodiments of the present disclosure, the lithium source may be at least one of lithium carbonate, lithium hydroxide, lithium nitrate, and lithium oxalate.

In some embodiments of the present disclosure, a molar ratio of cobalt element in the LCO precursor to lithium element in the lithium source may be 1:(1.0-1.2).

In some embodiments of the present disclosure, the roasting may be conducted at 900° C. to 1,200° C. for 6 h to 18 h.

According to a preferred embodiment of the present disclosure, the present disclosure at least has the following beneficial effects.
1. In the present disclosure, a nano-scale vanadium pentoxide template agent is first prepared from ammonium metavanadate through a hydrothermal reaction, then the vanadium pentoxide is mixed with a cobalt salt solution, a resulting mixture is subjected to co-precipitation with a carbonate solution and a complexing agent to obtain vanadium-doped basic cobalt carbonate, and the vanadium-doped basic cobalt carbonate is subjected to calcination to obtain an LCO precursor. The LCO precursor can be sintered with a lithium source to obtain an LCO cathode material.
2. The vanadium pentoxide template agent can be hardly dissolved in the cobalt salt solution. Thus, during the co-precipitation, cobalt ions react with carbonate ions and hydroxide ions to produce basic cobalt carbonate, and co-precipitation is carried on with the vanadium pentoxide template agent as a seed crystal to obtain a cobalt carbonate precipitate with prominent crystallinity. When an LCO cathode material is prepared by the subsequent sintering, the prominent crystallinity can be maintained to avoid cracking of the LCO material and improve the cycling performance of the material. In addition, during the co-precipitation, vanadium pentoxide is easily dissolved in a slightly-alkaline solution to produce metavanadate radical, which further reacts with cobalt ions in the solution to produce cobalt vanadate, such that the anion is replaced by vanadium to obtain a vanadium-doped LCO precursor. When the LCO precursor is sintered with a lithium source, the cobalt vanadate further undergoes a crystallization reaction to obtain a vanadium-doped LCO cathode material.
3. Due to the doping of high-valent vanadium, the prepared LCO cathode material exhibits excellent lattice stability and higher specific capacity during a charge-discharge process.

### BRIEF DESCRIPTION OF THE DRAWINGS

The present disclosure is further described below with reference to accompanying drawings and examples.

FIG. 1 is a scanning electron microscopy (SEM) image of the LCO prepared in Example 1 of the present disclosure.

### DETAILED DESCRIPTION

The concepts and technical effects of the present disclosure are clearly and completely described below in conjunction with examples, such as to allow the objectives, features and effects of the present disclosure to be fully understood. Apparently, the described examples are merely some rather than all of the examples of the present disclosure. All other examples obtained by those skilled in the art based on the examples of the present disclosure without creative efforts should fall within the protection scope of the present disclosure.

### Preparation of a Vanadium Pentoxide Template Agent:

AMV, deionized water, PVP K30, and EG were taken according to a ratio of 1 g:30 mL:10 g:100 mL; AMV was dissolved in deionized water to obtain an AMV solution, and PVP K30 was dissolved in EG to obtain a PVP solution; the AMV solution and the PVP solution were mixed and transferred to a hydrothermal reactor to undergo a reaction at 180° C. for 24 h; and a resulting precipitate was washed and then calcined at 500° C. for 2 h in an air atmosphere to obtain the micro-spherical vanadium pentoxide template agent with a particle size of 50 nm to 100 nm.

### EXAMPLE 1

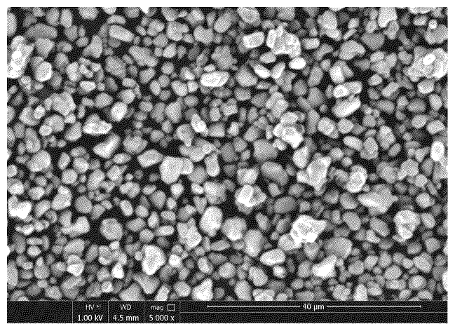

An LCO cathode material was prepared in this example, and a specific preparation process was as follows:
Step 1. According to a cobalt-to-vanadium molar ratio of 10:0.1, the vanadium pentoxide template agent was added to a cobalt sulfate solution with a concentration of 2.0 mol/L, and a resulting mixture was thoroughly mixed to obtain a mixed solution.
Step 2. A sodium carbonate solution with a concentration of 2.0 mol/L was prepared as a precipitating agent.
Step 3. Aqueous ammonia with a concentration of 12.0 mol/L was prepared as a complexing agent.
Step 4. The mixed solution prepared in step 1, the sodium carbonate solution prepared in step 2, and the aqueous ammonia prepared in step 3 were concurrently fed into a reactor to allow a reaction at a stirring speed of 200 r/min, a pH of 8, a temperature of 70° C., and an ammonia concentration of 5 g/L.
Step 5. When it was detected that D50 of a resulting material in the reactor reached 8.0 μm, the feeding was stopped and aging was conducted for 48 h.
Step 6. A precipitate in the reactor was separated through SLS, washed with pure water, and dried at 100° C. for 30 h.
Step 7. The dried precipitate was placed in a tube furnace; an inert gas was introduced into the tube furnace for protection, and a temperature therein was raised from room temperature to a temperature of 200° C. at a heating rate of 10° C./min and held for 6 h, and then raised to 600° C. and held for 2 h; then an oxidizing gas was introduced instead of the inert gas, and the temperature of 600° C. was held for 6 h; and a product was cooled, crushed, and sieved to obtain an LCO precursor material.
Step 8. According to a cobalt-to-lithium molar ratio of 1:1, the LCO precursor material obtained in step 7 was mixed with lithium carbonate, and a resulting mixture was roasted at 900° C. for 18 h in an air atmosphere, then crushed, sieved, and subjected to iron removal to obtain the LCO cathode material. FIG. 1 was an SEM image of the LCO prepared in this example, and it can be seen from the FIGURE that the LCO particles had a very-compact blocky structure and were not easy to crack.

### EXAMPLE 2

An LCO cathode material was prepared in this example, and a specific preparation process was as follows:
Step 1. According to a cobalt-to-vanadium molar ratio of 10:1, the vanadium pentoxide template agent was added to a cobalt nitrate solution with a concentration of 1.5 mol/L, and a resulting mixture was thoroughly mixed to obtain a mixed solution.
Step 2. A sodium carbonate solution with a concentration of 1.5 mol/L was prepared as a precipitating agent.
Step 3. Aqueous ammonia with a concentration of 9.0 mol/L was prepared as a complexing agent.
Step 4. The mixed solution prepared in step 1, the sodium carbonate solution prepared in step 2, and the aqueous ammonia prepared in step 3 were concurrently fed into a reactor to allow a reaction at a stirring speed of 350 r/min, a pH of 8.5, a temperature of 75° C., and an ammonia concentration of 8 g/L.
Step 5. When it was detected that D50 of a resulting material in the reactor reached 6.0 μm, the feeding was stopped and aging was conducted for 60 h.
Step 6. A precipitate in the reactor was separated through SLS, washed with pure water, and dried at 150° C. for 20 h.
Step 7. The dried precipitate was placed in a tube furnace; an inert gas was introduced into the tube furnace for protection, and a temperature therein was raised from room temperature to a temperature of 250° C. at a heating rate of 5° C./min and held for 5 h, and then raised to 700° C. and held for 1.5 h; then an oxidizing gas was introduced instead of the inert gas, and the temperature of 700° C. was held for 5 h; and a product was cooled, crushed, and sieved to obtain an LCO precursor material.
Step 8. According to a cobalt-to-lithium molar ratio of 1:1.1, the LCO precursor material obtained in step 7 was mixed with lithium hydroxide, and a resulting mixture was roasted at 1,050° C. for 12 h in an air atmosphere, then crushed, sieved, and subjected to iron removal to obtain the LCO cathode material.

### EXAMPLE 3

An LCO cathode material was prepared in this example, and a specific preparation process was as follows:
Step 1. According to a cobalt-to-vanadium molar ratio of 10:2, the vanadium pentoxide template agent was added to a cobalt chloride solution with a concentration of 1.0 mol/L, and a resulting mixture was thoroughly mixed to obtain a mixed solution.
Step 2. A sodium carbonate solution with a concentration of 1.0 mol/L was prepared as a precipitating agent.
Step 3. Aqueous ammonia with a concentration of 6.0 mol/L was prepared as a complexing agent.
Step 4. The mixed solution prepared in step 1, the sodium carbonate solution prepared in step 2, and the aqueous ammonia prepared in step 3 were concurrently fed into a reactor to allow a reaction at a stirring speed of 500 r/min, a pH of 9, a temperature of 80° C., and an ammonia concentration of 10 g/L.
Step 5. When it was detected that D50 of a resulting material in the reactor reached 4.0 μm, the feeding was stopped and aging was conducted for 72 h.
Step 6. A precipitate in the reactor was separated through SLS, washed with pure water, and dried at 200° C. for 10 h.
Step 7. The dried precipitate was placed in a tube furnace; an inert gas was introduced into the tube furnace for protection, and a temperature therein was raised from room temperature to a temperature of 300° C. at a heating rate of 10° C./min and held for 4 h, and then raised to 800° C. and held for 1 h; then an oxidizing gas was introduced instead of the inert gas, and the temperature of 800° C. was held for 4 h; and a product was cooled, crushed, and sieved to obtain an LCO precursor material.
Step 8. According to a cobalt-to-lithium molar ratio of 1:1, the LCO precursor material obtained in step 7 was mixed with lithium nitrate, and a resulting mixture was roasted at 1,200° C. for 6 h in an air atmosphere, then crushed, sieved, and subjected to iron removal to obtain the LCO cathode material.

### COMPARATIVE EXAMPLE 1

An LCO cathode material was prepared in this comparative example, which was different from Example 1 in that the vanadium pentoxide template agent was not added. A specific preparation process was as follows:
Step 1. A cobalt sulfate solution with a concentration of 2.0 mol/L was prepared.
Step 2. A sodium carbonate solution with a concentration of 2.0 mol/L was prepared as a precipitating agent.
Step 3. Aqueous ammonia with a concentration of 12.0 mol/L was prepared as a complexing agent.
Step 4. The cobalt sulfate solution prepared in step 1, the sodium carbonate solution prepared in step 2, and the aqueous ammonia prepared in step 3 were concurrently fed into a reactor to allow a reaction at a stirring speed of 200 r/min, a pH of 8, a temperature of 70° C., and an ammonia concentration of 5 g/L.
Step 5. When it was detected that D50 of a resulting material in the reactor reached 8.0 μm, the feeding was stopped and aging was conducted for 48 h.
Step 6. A precipitate in the reactor was separated through SLS, washed with pure water, and dried at 100° C. for 30 h.
Step 7. The dried precipitate was placed in a tube furnace; an inert gas was introduced into the tube furnace for protection, and a temperature therein was raised from room temperature to a temperature of 200° C. at a heating rate of 10° C./min and held for 6 h, and then raised to 600° C. and held for 2 h; then an oxidizing gas was introduced instead of the inert gas, and the temperature of 600° C. was held for 6 h; and a product was cooled, crushed, and sieved to obtain an LCO precursor material.
Step 8. According to a cobalt-to-lithium molar ratio of 1:1, the LCO precursor material obtained in step 7 was mixed with lithium carbonate, and a resulting mixture was roasted at 900° C. for 18 h in an air atmosphere, then crushed, sieved, and subjected to iron removal to obtain the LCO cathode material.

### COMPARATIVE EXAMPLE 2

An LCO cathode material was prepared in this comparative example, which was different from Example 2 in that the vanadium pentoxide template agent was not added. A specific preparation process was as follows:
Step 1. A cobalt nitrate solution with a concentration of 1.5 mol/L was prepared.
Step 2. A sodium carbonate solution with a concentration of 1.5 mol/L was prepared as a precipitating agent.
Step 3. Aqueous ammonia with a concentration of 9.0 mol/L was prepared as a complexing agent.
Step 4. The cobalt nitrate solution prepared in step 1, the sodium carbonate solution prepared in step 2, and the aqueous ammonia prepared in step 3 were concurrently fed into a reactor to allow a reaction at a stirring speed of 350 r/min, a pH of 8.5, a temperature of 75° C., and an ammonia concentration of 8 g/L.
Step 5. When it was detected that D50 of a resulting material in the reactor reached 6.0 μm, the feeding was stopped and aging was conducted for 60 h.
Step 6. A precipitate in the reactor was separated through SLS, washed with pure water, and dried at 150° C. for 20 h.
Step 7. The dried precipitate was placed in a tube furnace; an inert gas was introduced into the tube furnace for protection, and a temperature therein was raised from room temperature to a temperature of 250° C. at a heating rate of 5° C./min and held for 5 h, and then raised to 700° C. and held for 1.5 h; then an oxidizing gas was introduced instead of the inert gas, and the temperature of 700° C. was held for 5 h; and a product was cooled, crushed, and sieved to obtain an LCO precursor material.
Step 8. According to a cobalt-to-lithium molar ratio of 1:1.1, the LCO precursor material obtained in step 7 was mixed with lithium hydroxide, and a resulting mixture was roasted at 1,050° C. for 12 h in an air atmosphere, then crushed, sieved, and subjected to iron removal to obtain the LCO cathode material.

### COMPARATIVE EXAMPLE 3

An LCO cathode material was prepared in this comparative example, which was different from Example 3 in that the vanadium pentoxide template agent was not added. A specific preparation process was as follows:
Step 1. A cobalt chloride solution with a concentration of 1.0 mol/L was prepared.
Step 2. A sodium carbonate solution with a concentration of 1.0 mol/L was prepared as a precipitating agent.
Step 3. Aqueous ammonia with a concentration of 6.0 mol/L was prepared as a complexing agent.
Step 4. The cobalt chloride solution prepared in step 1, the sodium carbonate solution prepared in step 2, and the aqueous ammonia prepared in step 3 were concurrently fed into a reactor to allow a reaction at a stirring speed of 500 r/min, a pH of 9, a temperature of 80° C., and an ammonia concentration of 10 g/L.
Step 5. When it was detected that D50 of a resulting material in the reactor reached 4.0 μm, the feeding was stopped and aging was conducted for 72 h.
Step 6. A precipitate in the reactor was separated through SLS, washed with pure water, and dried at 200° C. for 10 h.
Step 7. The dried precipitate was placed in a tube furnace; an inert gas was introduced into the tube furnace for protection, and a temperature therein was raised from room temperature to a temperature of 300° C. at a heating rate of 10° C./min and held for 4 h, and then raised to 800° C. and held for 1 h; then an oxidizing gas was introduced instead of the inert gas, and the temperature of 800° C. was held for 4 h; and a product was cooled, crushed, and sieved to obtain an LCO precursor material.
Step 8. According to a cobalt-to-lithium molar ratio of 1:1, the LCO precursor material obtained in step 7 was mixed with lithium nitrate, and a resulting mixture was roasted at 1,200° C. for 6 h in an air atmosphere, then crushed, sieved, and subjected to iron removal to obtain the LCO cathode material.

### TEST EXAMPLE

The LCO cathode material obtained from each of the examples 1 to 3 and comparative examples 1 to 3 (as an active material), acetylene black (as a conductive agent), and polyvinylidene fluoride (PVDF) (as a binder) were weighed and mixed in a ratio of 92:4:4, then a specified amount of an organic solvent N-methylpyrrolidone (NMP) was added, and a resulting mixture was stirred and coated on an aluminum foil to obtain a positive electrode sheet; and then with a metal lithium sheet as a negative electrode, a CR2430 button battery was assembled in an argon-filled glove box. An electrical performance test was conducted on a CT2001A Land test system under the following conditions: voltage: 3.0 V to 4.48 V, current density: 1 C=180 mAh/g, and test temperature: 25±1° C. Test results were shown in Table 1.

TABLE 1
Electrochemical performance of LCO

| | Discharge capacity at | Capacity retention rate after |
|---|---|---|
| | 0.1 C/4.48 V, mAh/g | 600 cycles at 0.1 C/4.48 V |
| Example 1 | 232.6 | 88% |
| Example 2 | 247.3 | 85% |
| Example 3 | 258.6 | 82% |
| Comparative | 208.2 | 72% |
| Example 1 | | |
| Comparative | 208.6 | 71% |
| Example 2 | | |
| Comparative | 208.8 | 68% |
| Example 3 | | |

It can be seen from Table 1 that the discharge capacity and cycling performance of the examples were significantly superior to the discharge capacity and cycling performance of the comparative examples, which was attributed to the addition of the vanadium pentoxide template agent in the examples. When vanadium pentoxide was used as a seed crystal for co-precipitation, a precursor with prominent crystallinity was obtained, and an LCO cathode material obtained by the sintering of the precursor inherited the prominent crystallinity, which made the LCO cathode material difficult to crack and improved the cycling performance of the cathode material. In addition, vanadium pentoxide can be dissolved to produce metavanadate radical during the co-precipitation, which reacted with cobalt ions to produce cobalt vanadate, such that vanadium was doped into the LCO material smoothly, which made the cathode material have prominent lattice stability and higher specific capacity.

The examples of the present disclosure are described in detail with reference to the accompanying drawings, but the present disclosure is not limited to the above examples. Within the scope of knowledge possessed by those of ordinary skill in the technical field, various changes can also be made without departing from the purpose of the present disclosure. In addition, the examples and features in the examples in the present disclosure may be combined with each other in a non-conflicting situation.

1. A method for preparing a lithium cobalt oxide (LCO) precursor through template-induced growth, comprising the following steps:
S1: mixing an ammonium metavanadate aqueous solution with a polyvinylpyrrolidone solution to allow a hydrothermal reaction, and subjecting a resulting precipitate to calcination in an aerobic atmosphere to obtain a vanadium pentoxide template agent, wherein the polyvinylpyrrolidone solution is prepared by dissolving polyvinylpyrrolidone in an alcohol;
S2: adding the vanadium pentoxide template agent to a cobalt salt solution to obtain a suspension, concurrently feeding the suspension, a carbonate solution, and a complexing agent to allow a reaction, and when a particle size of a reacted material reaches a target value, conducting aging; and
S3: conducting solid-liquid separation on an aged material to obtain a precipitate, and subjecting the precipitate first to anaerobic calcination and then to aerobic calcination to obtain the LCO precursor.

2. The method according to claim 1, wherein in S1, the ammonium metavanadate aqueous solution is prepared by dissolving ammonium metavanadate in water; and the ammonium metavanadate, the water, the polyvinylpyrrolidone, and the alcohol are in a ratio of (1-3) g:(25-35) mL:(8-12) g:(90-110) mL.

3. The method according to claim 1, wherein in S1, the hydrothermal reaction is conducted at 170° C. to 190° C. for 20 h to 28 h.

4. The method according to claim 1, wherein in S1, the vanadium pentoxide template agent has a particle size of 50 nm to 100 nm.

5. The method according to claim 1, wherein in S2, the cobalt salt solution has a concentration of 1.0 mol/L to 2.0 mol/L; and a molar ratio of cobalt in the cobalt salt solution to vanadium in the vanadium pentoxide template agent is 10: (0.1-2).

6. The method according to claim 1, wherein in S2, the carbonate solution is a sodium carbonate solution with a concentration of 1.0 mol/L to 2.0 mol/L.

7. The method according to claim 1, wherein in S2, the reaction is conducted at a pH of 8 to 9, a temperature of 70° C. to 80° C., and an ammonia concentration of 5 g/L to 10 g/L.

8. The method according to claim 1, wherein in S2, the aging is conducted for 48 h to 72 h.

9. The method according to claim 1, wherein in S3, the anaerobic calcination is conducted as follows: introducing an inert gas, heating from room temperature to a temperature of 200° C. to 300° C. at a heating rate of 0.5° C./min to 10° C./min and holding the temperature for 4 h to 6 h, and then heating to a temperature of 600° C. to 800° C. and holding the temperature for 1 h to 2 h; and the aerobic calcination is conducted as follows: introducing an oxidizing gas, and holding the temperature of 600° C. to 800° C. for 4 h to 6 h.

10. Use of the method according to claim 1 in the preparation of LCO or a lithium-ion battery.

11. Use of the method according to claim 2 in the preparation of LCO or a lithium-ion battery.

12. Use of the method according to claim 3 in the preparation of LCO or a lithium-ion battery.

13. Use of the method according to claim 4 in the preparation of LCO or a lithium-ion battery.

14. Use of the method according to claim 5 in the preparation of LCO or a lithium-ion battery.

15. Use of the method according to claim 6 in the preparation of LCO or a lithium-ion battery.

16. Use of the method according to claim 7 in the preparation of LCO or a lithium-ion battery.

17. Use of the method according to claim 8 in the preparation of LCO or a lithium-ion battery.

18. Use of the method according to claim 9 in the preparation of LCO or a lithium-ion battery.
